(19) United States
(12) Patent Application Publication
(10) Pub. No.: US 2026/0050241 A1
(43) Pub. Date: Feb. 19, 2026

(54) METHOD AND APPARATUS FOR ADJUSTING PARAMETER OF COMPONENT, DEVICE, AND PROGRAM PRODUCT

(71) Applicants: Lemon Inc., Grand Cayman (KY); Beijing Zitiao Network Technology Co., Ltd., Beijing (CN)

(72) Inventors: Huaqing LUO, SG - SINGAPORE (SG); Pandeng LI, Beijing (CN); Dezheng WANG, Beijing (CN); Tong SHEN, Beijing (CN); Zhaonan XU, Beijing (CN)

(21) Appl. No.: 19/326,559

(22) Filed: Sep. 11, 2025

(30) Foreign Application Priority Data
Dec. 13, 2024 (CN) 202411844669.9

(51) Int. Cl. G05B 13/02

(52) U.S. Cl. CPC G05B 13/024

(57) ABSTRACT

Embodiments of the present disclosure provide a method, an apparatus, a device, a storage medium, and a computer program product for adjusting a parameter of a component. The method includes obtaining a target component type and a target adjustment for a target parameter. The method further includes determining, from a plurality of components, at least one target component belonging to the target component type. The method further includes adjusting the target parameter of the at least one target component according to the target adjustment for the target parameter.

### CROSS-REFERENCE TO RELATED APPLICATION

This application claims priority to Chinese Application No. 202411844669.9 filed on Dec. 13, 2024, the disclosure of which is incorporated herein by reference in its entirety.

### FIELD

The present disclosure generally relates to the field of computers, and more particularly to a method and an apparatus for adjusting a parameter of a component, a device, a computer-readable storage medium, and a computer program product.

### BACKGROUND

An application development framework is used to simplify and accelerate the creation process of applications. By integrating a series of tools and functions, developers can focus more on the construction of core business logic and intelligent rules without building the underlying architecture from scratch. From the perspective of component orchestration, these frameworks usually use a graph structure to organize various parts. For example, an artificial intelligence application development framework belongs to this category.

The application development framework allows users to graphically organize components, that is, to build an application workflow by defining nodes and edges, so that the orchestrated components are presented in a visual manner. The framework may describe and arrange component interactions within the application.

### SUMMARY

According to example embodiments of the present disclosure, a method, an apparatus, a device, a computer storage medium, and a computer program product for adjusting a parameter of a component are provided.

In a first aspect of the present disclosure, a method for adjusting a parameter of a component is provided, the method includes obtaining a target component type and a target adjustment for a target parameter. The method further includes determining, from a plurality of components, at least one target component belonging to the target component type. The method further includes adjusting the target parameter of the at least one target component according to the target adjustment for the target parameter.

In a second aspect of the present disclosure, an apparatus for adjusting a parameter of a component is provided, the apparatus includes an obtaining module configured to obtain a target component type and a target adjustment for a target parameter. The apparatus further includes a determination module configured to determine, from a plurality of components, at least one target component belonging to the target component type. The apparatus further includes an adjustment module configured to adjust the target parameter of the at least one target component according to the target adjustment for the target parameter.

In a third aspect of the present disclosure, an electronic device is provided, the electronic device includes at least one processing unit and at least one memory. The at least one memory is coupled to the at least one processing unit, and stores instructions executable by the at least one processing unit. The instructions, when executed by the at least one processing unit, cause the electronic device to perform the method described according to the first aspect of the present disclosure.

In a fourth aspect of the present disclosure, a computer-readable storage medium is provided, the computer-readable storage medium has machine-executable instructions stored thereon. The machine-executable instructions, when executed by a device, cause the device to perform the method described according to the first aspect of the present disclosure.

In a fifth aspect of the present disclosure, a computer program product is provided, the computer program product includes computer-executable instructions. The computer-executable instructions, when executed by a processor, implement the method described according to the first aspect of the present disclosure.

The Summary section is provided to introduce a series of concepts in a simplified form, which will be further described in the Detailed Description section below. The Summary section is not intended to identify key features or essential features of the present disclosure, nor is it intended to limit the scope of the present disclosure. Other features of the present disclosure will become readily understood through the following description.

### BRIEF DESCRIPTION OF THE DRAWINGS

FIG. 1 shows a schematic diagram of an example environment in which embodiments of the present disclosure may be implemented;

FIG. 2 shows a flowchart of a method for adjusting a parameter of a component according to an embodiment of the present disclosure;

FIG. 3 shows a schematic diagram of adjusting a target parameter according to an embodiment of the present disclosure;

FIG. 4 shows a schematic diagram of adjusting a parameter of a component according to an embodiment of the present disclosure;

FIG. 5 shows a schematic diagram of adjusting a parameter of a component according to an embodiment of the present disclosure;

FIG. 6 shows a schematic diagram of adjusting a parameter of a component according to an embodiment of the present disclosure;

FIG. 7 shows a schematic block diagram of an example apparatus according to some embodiments of the present disclosure; and

FIG. 8 shows a block diagram of an example device that may be used to implement the embodiments of the present disclosure.

Throughout the drawings, the same or similar reference numbers refer to the same or similar elements.

### DETAILED DESCRIPTION OF EMBODIMENTS

The names of messages or information exchanged between multiple apparatuses in the implementations of the present disclosure are used for illustrative purposes only, and are not used to limit the scope of these messages or information. It should be understood that before using the technical solutions disclosed in the embodiments of the present disclosure, the user should be informed of the type, range of use, use scenarios, etc. of personal information involved in the present disclosure and obtain the authorization of the user in an appropriate manner in accordance with relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure. As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree”or “disagree”to provide the personal information to the electronic device.

It should be understood that the above process of notifying and obtaining user authorization is only illustrative and does not limit the implementations of the present disclosure, and other methods that satisfy relevant laws and regulations may also be applied to the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The terms “first”, “second”, etc. may refer to different or same objects, unless explicitly stated. Other explicit and implicit definitions may also be included below.

When running components in an application development framework, the components may transmit parameters according to agreed parameters, so that task processing is gradually implemented at each component. In some cases, it may be necessary to intervene in the parameters of the components. For example, a user desires to modify a model name, and in implementation, it is necessary to adjust values of parameters for the model name in some components in the framework. In the related art, a manner of adjusting the parameter is to input a name of a variable and a modified value. For example, component 1 has a variable named a, which represents a name of a certain model, then the user may input a and the value of a. If multiple components of the framework belong to different component types and have repeated variables, for example, components 1-2 belong to component type A, component 3 belongs to component type B, and component 3 also includes a variable a, but it represents coefficient information of component 3. If only the name of the variable and the modified value are input, the variable a of component 3 will also be modified, resulting in confusion in parameter adjustment.

In this regard, the present disclosure provides a method for adjusting a parameter of a component. The method is capable of performing matching in a dimension of a target component type by using the target component type, and obtain at least one target component belonging to the target component type by filtering, so as to accurately adjust a parameter of the target component without causing a parameter of a component of a non-target component type to be changed, thereby avoiding confusion in parameter adjustment.

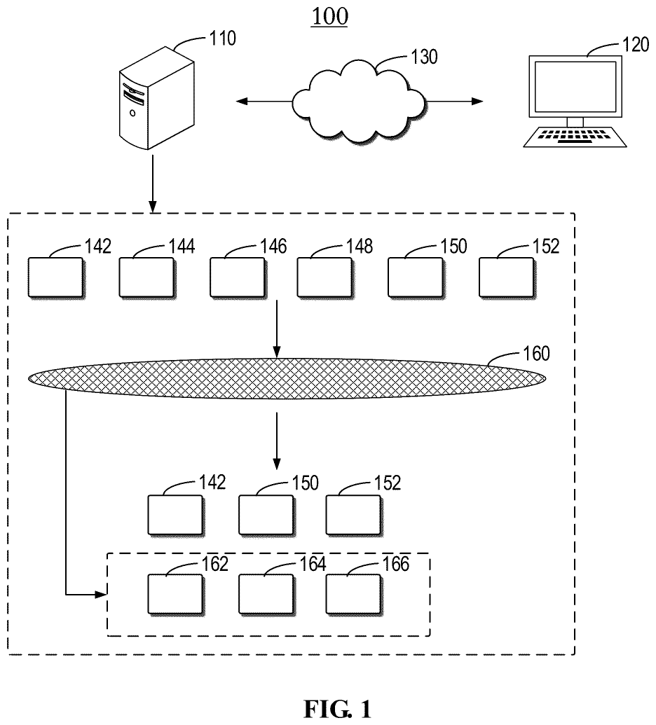

The embodiments of the present disclosure will be further described in detail below with reference to the drawings, where FIG. 1 shows a schematic diagram of an example environment 100 in which the embodiments of the present disclosure may be implemented. The example environment 100 includes a computing device 110, a computing device 120, components 142, 144, 146, 148, 150, 152, and a matcher 160. The computing device 110 may process data and be deployed with an application development framework, for example, a development framework for an artificial intelligence application, for providing an orchestration service and running orchestrated components for user equipment (for example, the computing device 120) accessing the computing device 110. In some embodiments, the computing device 120 communicates with the computing device 110 via a network 130. The network 130 may include a wired network, a wireless network, or a combination thereof, for providing communication between the computing device 120 and the computing device 110. In some embodiments, the computing device 120 may be connected to the computing device 110 via a data line, and the present disclosure does not limit a connection manner between the computing device 110 and the computing device 120.

The computing device 120 may provide a plurality of components to the computing device 110. A developer may complete the definition of various components on the computing device 120, and this definition may be implemented in various programming languages, which cover different levels from low-level to high-level and are suitable for different programming paradigms, including but not limited to strongly typed languages such as Golang and C. For example, for an application scenario that requires tightly coupled hardware resources, the C language may be selected for development. As a procedural programming language, the C language not only provides the operation capability for the underlying hardware, but also has good portability and execution efficiency. For another example, when the design of the application tends to utilize modularity, inheritance, and polymorphism, an object-oriented programming language may be used.

In this embodiment, the computing device 110 may obtain a target component type and a target adjustment for a target parameter. The target component type and the target adjustment for the target parameter may come from various aspects, such as user input, a system configuration file, or automatically detected environment characteristics. For example, if the user desires to modify a variable a representing a model name to “model X”, and the variable is defined in a component type A, the user may input “modify the value of the variable a of the component type A to ‘model X’”. In this embodiment, the user input is provided in the form of pseudo code, and in actual applications, the pseudo code may be modified into appropriate code instructions according to language features applied in the framework.

The computing device 110 may determine, from the plurality of components 142-152, at least one target component belonging to the target component type. As shown in FIG. 1, the matcher 160 in the computing device 110 may determine component types of the plurality of components 142-152, to obtain a matched component by filtering as a target component therefrom, including components 142, 150, and 152. As an example, the matcher 160 may read parameter information in the plurality of components 142-152 to determine types of these parameters, which may reflect the component types of the corresponding components. The matcher 160 may perform further matching to obtain at least one target component, that is, the components 142, 150, and 152, according to the types of the parameters. Because parameters are defined at different positions, for example, some parameters are defined in the component type and some parameters are defined in a component implementation (for example, a specific component instance), different parameters also have different types. If the component 142 has a parameter a, and the parameter a is defined in the component type A, it indicates that the component type of the component 142 is the component type A. In this way, the computing device 110 may infer the component type of each component one by one according to the type of the parameter, and determine the component belonging to the target component type as the target component.

The computing device 110 may adjust the target parameter of the at least one target component according to the target adjustment for the target parameter. The computing device 110 may obtain parameter sets 162, 164, and 166 for the target components 142, 150, and 152, respectively. For example, the target component 142 inherits the component type A, and is necessarily associated with the parameter set defined in the component type A. Therefore, the parameter set 162 of the target component type may be obtained, and whether the parameters in the parameter set 162 include the target parameter is detected. If yes, it may be modified; if not, it indicates that the target parameter is defined in the component, and the parameter defined in the target component 142 may be detected to find the target parameter and modify it. Similarly, the components 150 and 152 may also complete parameter adjustment in a similar manner. After the target component is determined, the component whose parameters has the same parameter name and that belongs to a different component type may be excluded, so only the value of the parameter of the target component may be changed. According to the method of the present disclosure, matching in the dimension of the target component type may be performed by using the target component type, and the at least one target component belonging to the target component type may be obtained by filtering, so as to accurately adjust the parameter of the target component without causing the parameter of the component of the non-target component type to be changed, thereby avoiding confusion in parameter adjustment.

As shown in FIG. 1, in the environment 100, the network 130 may be used to transmit data between the computing device 110 and the computing device 120. The network 130 has a theoretical bandwidth, and the theoretical bandwidth refers to a maximum transmission speed supported by the network 130, which represents a maximum amount of data that may be transmitted by the network 130 in an ideal condition, and is usually measured by the number of bits transmitted per second (bps). For example, if the theoretical bandwidth of the network 130 is 100 Mbps, it indicates that in an ideal condition, it may transmit one hundred million bits of data per second. However, in practice, due to other factors (such as signal interference, bandwidth sharing, and transmission delay) that may exist in the network, the actual transmission speed of 100 Mbps may not be reached.

As understood by those of ordinary skill in the art, an instance of the computing device 110 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, CDNs, and big data and artificial intelligence platforms. The servers may be directly or indirectly connected in a wired or wireless communication manner, which is not limited in the present application.

The computing device 120 may be any type of mobile computing device, including a mobile computer (such as a personal digital assistant (PDA), a laptop computer, a notebook computer, a tablet computer, or a netbook), a mobile phone (such as a cellular phone or a smart phone), a wearable computing device (such as a smart watch, a head-mounted device, including smart glasses), or other types of mobile devices. In some embodiments, the computing device 120 may also be a stationary computing device, such as a desktop computer, a game console, or a smart TV.

It should be understood that the architecture and functions in the example environment 100 are described only for the purpose of illustration, without suggesting any limitation to the scope of the present disclosure. The embodiments of the present disclosure may also be applied to other environments with different structures and/or functions.

The process according to the embodiments of the present disclosure will be described in detail below with reference to other drawings. For ease of understanding, the specific data mentioned in the following description is exemplary and is not used to limit the protection scope of the present disclosure. It should be understood that the embodiments described below may further include additional actions not shown and/or may omit the shown actions, and the scope of the present disclosure is not limited in this regard.

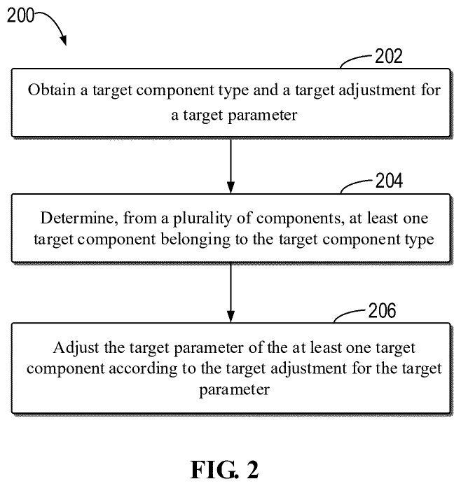

FIG. 2 shows a flowchart of a method 200 for adjusting a parameter of a component according to some embodiments of the present disclosure. In this embodiment, the method may be performed by the computing device 110. At a block 202, a target component type and a target adjustment for a target parameter are obtained. The component type may also be referred to as component abstraction, and include code content such as defined functions and variables, and components that implement the component type or component abstraction should have these functions and variables. The component type usually cannot be implemented in a programming language, but may be inherited by a specific component instance, so that the component type of the component is the inherited component type.

For example, a structure 1 may be defined in a component type A, where the structure 1 includes a variable a and a variable b, and the component type A may define a function a1 for modifying the variable a and a function b1 for modifying the variable b. A component 1 and a component 2 may be instances of the component type A, and inherit code content such as the structure and functions of the component type A. Furthermore, the component 1 may be individually associated with the structure 1, instead of sharing the structure with other component instances (for example, the component 2) that inherit the component type A. The target parameter is a parameter that is expected to be adjusted, for example, the variable a. The target adjustment may be a function name (which may be referred to as a “function signature” in some programming languages) for adjusting the variable a, and the function name is defined in the component type A, and the component type A may define a specific adjustment action for the function name, for example, an assignment operation may be defined.

At a block 204, at least one target component belonging to the target component type is determined from a plurality of components. In this operation, the component types of the plurality of components are matched to determine a component being of the target component type. For example, if the target component type is the component type A, it may be determined that the component 1 and the component 2 belong to the target component. As described above, when determining the at least one target component belonging to the target component type, for example, the component type of the component may be determined according to the type of the parameter of each component. If the component type of the component 3 is the component type B, which does not include the component type A, it may be determined that the parameter of the component 3 does not need to be adjusted. This may avoid confusion in parameter adjustment.

At a block 206, the target parameter of the at least one target component is adjusted according to the target adjustment for the target parameter. After the target component is determined, each target component may be traversed according to specific adjustment content (that is, an adjustment function name and a value) to implement corresponding adjustment of the parameter of each target component. According to the method of the present disclosure, matching in the dimension of the target component type may be performed by using the target component type, and the at least one target component belonging to the target component type may be obtained by filtering, so as to accurately adjust the parameter of the target component without causing the parameter of the component of the non-target component type to be changed, thereby avoiding confusion in parameter adjustment. When adjusting the parameter, it is not required that all parameters of the component may be adjusted.

As described above, matching of the target component may be implemented according to the type of the parameter. In an embodiment, type information of a plurality of first parameters of the plurality of components is obtained. The first parameter may be a function defined by the component type. For example, in a Golang language environment, the first parameter may be an optional parameter (that is, a parameter of an Option type) provided in the definition of the target type. Each component may be associated with one structure of the Option type defined by the component type inherited by the component, and the structure may include a plurality of parameters.

In an embodiment, the target component type is matched against the type information of the plurality of first parameters. The first parameter refers to a parameter that may reflect the component type. In many cases, some programming languages (such as the Golang language) are provided with optional parameters, such as parameters of the Option type. The type of the optional parameter is consistent with the type of the grammatical structure that defines the optional parameter. For example, in the definition of the component type A, the component type A may provide the definition of the structure of the Option type, and the plurality of parameters are defined in the structure of the Option type. The component 1 is a specific instance of the component type A, then the component 1 may be associated with (for example, have) an Option structure of the component type A, and the type of the parameter of the Option structure of the component type A associated with the component 1 is the component type A. In this way, it may be determined that the component type of the component 1 is the component type A. As an example, a Boolean operation may be performed. If the result of the Boolean operation between the type information of a certain first parameter and the target component type is 1, it indicates that the two are the same, and the type information of the first parameter is the target component type; otherwise, the two are different. In an embodiment, if type information of at least one first parameter among the type information of the plurality of first parameters matches the target component type, a component including the type information of the at least one first parameter is determined as the at least one target component. The type information of the first parameter is the target component type, indicating that the component associated with the first parameter inherits the target component type, so that the component may have the first parameter.

In this embodiment, the type information of the first parameters of the plurality of components is obtained to implement the inference of the component type of the component, and further matching of the plurality of components with the target component type may be implemented, which provides a simple and fast solution for determining or filtering to obtain the target component.

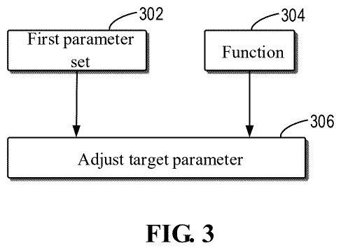

When adjusting the parameter based on this, the first parameter may be directly called to complete the adjustment task. FIG. 3 shows a schematic diagram of adjusting a target parameter according to an embodiment of the present disclosure. At 302, a first parameter set of a target component is obtained according to a target component type. The first parameter set may be a structure defined by the target component type, for example, a structure of an Option type, in which a plurality of parameters are defined, for example, a parameter a and a parameter b. Referring to the above example, assuming that the component type A is the target component type, because the component 1 is a component instance of the component type A, the component 1 may obtain the associated (or owned) Option structure of the component type A, and obtain the parameters therein to obtain the first parameter set. When obtaining the first parameter set, as an example, the computing device 110 may obtain an address of the first parameter set corresponding to the target component, and obtain the first parameter set according to the address.

At 304, a target adjustment is obtained according to the target component type. The target adjustment may be a function signature input by the user for adjusting the target parameter. Generally, when defining the first parameter, the target component type also defines a function signature and an adjustment action for modifying the first parameter, and the adjustment action may be a closure composed of several lines of code. When obtaining the target adjustment, the function signature may be used as a matching object, and the adjustment action (that is, the closure) corresponding to the function signature is obtained as the target adjustment. At 306, the target component adjusts the target parameter in the first parameter set using the target adjustment. Based on the content obtained at 302 and 304, the target parameter is modified according to a specific modification method in the target adjustment.

In this embodiment, not only the process of parameter adjustment is simplified, but also the adjustment operation is ensured to only affect the specified component and parameter, thereby avoiding the confusion in adjustment, and improving the stability and maintainability of the orchestrated product in the framework. Furthermore, through the explicit function signature and structure definition, the transparency and controllability of the parameter adjustment process are enhanced. Moreover, the target parameters of all target components belonging to the target component type may be adjusted in batch, thereby improving the adjustment efficiency.

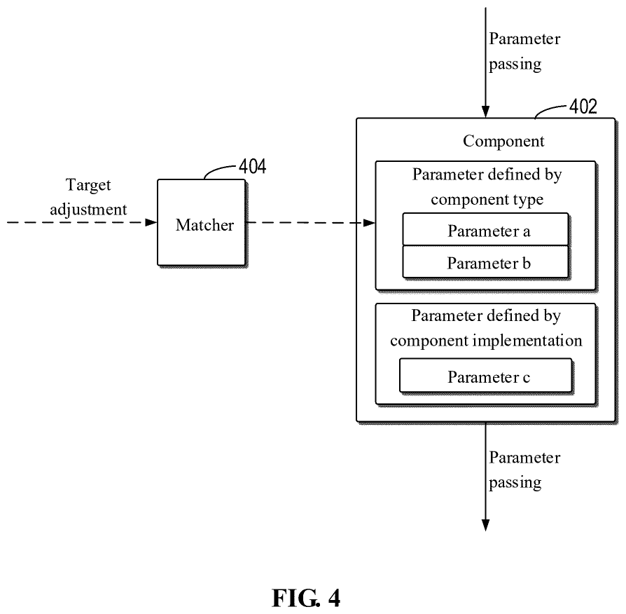

However, in some cases, not only the parameter in the component type dimension needs to be adjusted, but also the parameter of the specific component needs to be further adjusted. FIG. 4 shows a schematic diagram of adjusting a parameter of a component according to an embodiment of the present disclosure. As shown in FIG. 4, in the framework, a component 402 involves a variety of parameter passing, for example, it needs to receive a passed parameter from an upstream component to perform related calculations. The passed parameter belongs to a predetermined parameter and is usually not adjustable. The component may also pass the calculation result to a downstream component in the form of a passed parameter after task processing. In addition, the component may also involve adjustable parameters, such as a parameter a, a parameter b, and a parameter c. The parameter a and the parameter b are parameters defined by the component type, and the parameter c is a parameter defined by the component implementation. The parameter defined by the component implementation refers to a parameter defined specifically for the component during the implementation of the component, and may also be referred to as a parameter defined by the component instance.

The framework may be provided with a matcher 404, which may receive a target component type that needs to be adjusted and a target adjustment for a target parameter, determine, according to the target component type, that the component 402 is a target component, and then distribute the target adjustment to the component 402 to adjust the target parameter using the target adjustment. The target parameter may be any one or more of the parameter a, the parameter b, and the parameter c. In this embodiment, the matcher 404 may not only be accurate to the distribution in the component type dimension, but also to the distribution in the component implementation dimension, thereby further improving the accuracy of parameter modification and avoiding the confusion in adjustment.

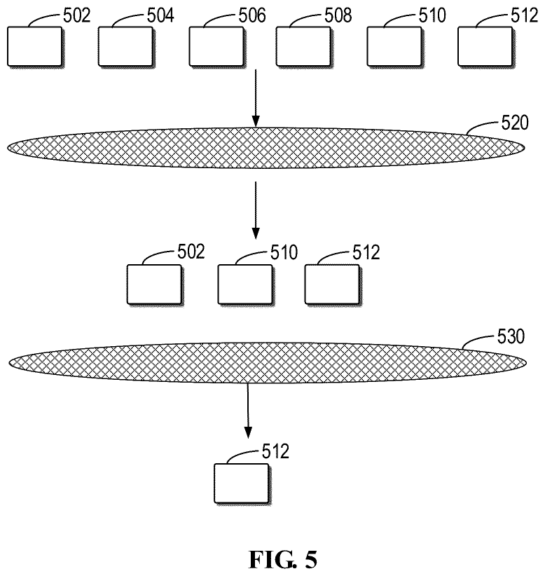

FIG. 5 shows a schematic diagram of adjusting a parameter of a component according to an embodiment of the present disclosure. In this embodiment, two rounds of distribution or matching may be performed. The application development framework includes components 502, 504, 506, 508, 510, and 512. In this embodiment, the computing device 110 may obtain a target component type and a target adjustment for a target parameter, where the target adjustment includes target implementation information for the target parameter. The target implementation information indicates in which component instance the target parameter is located. Assuming that the target component type is a component type A, the computing device 110 may determine, from the plurality of components 502-512 via a matcher 520, that the components 502, 510, and 512 belong to the component type A and may be used as target components. Because further matching is required, the components 502, 510, and 512 are hereinafter referred to as first components for clarity. The computing device 110 may obtain type information of a plurality of second parameters of the plurality of first components. The second parameter may be a parameter defined by the components 502, 510, and 512, respectively. That is, the first parameter is a parameter in the component type dimension, and the second parameter is a parameter in the component implementation dimension (or component instance dimension).

The computing device 110 may match the target implementation information against types of the plurality of second parameters in a matcher 530. If type information of at least one second parameter among the type information of the plurality of second parameters matches the target implementation information, a first component including the type information of the at least one second parameter is determined as at least one target component. The matching operation may be a Boolean operation, and the type information of the second parameter is multiplied by the target implementation information. If the result is 1, it indicates that the two are the same. If the result is 0, it indicates that the two are different. After matching by the matcher 530, it may be seen that only the first component 512 matches successfully, indicating that the component 512 has the target parameter. The target parameter of the component 512 may be adjusted according to the target adjustment. In this embodiment, the user may locate the target parameter to a specific component, that is, directly modify the parameter in the component dimension, which may more accurately implement precise control of parameter adjustment.

When adjusting the target parameter based on this, in an embodiment, a second parameter set of the first component 512 is obtained. In an embodiment, the target adjustment of the first component 512 is obtained. In an embodiment, the target parameter in the second parameter set is adjusted using the target adjustment. Since the target parameter is the target parameter in the component implementation dimension, the corresponding component should provide the definition for the second parameter and the definition for the target adjustment. Therefore, the target parameter and the adjustment operation may be obtained directly from the first component 512, thereby achieving precise adjustment of the target parameter.

Generally, the target component (that is, the first component 512 in the above embodiment) is defined with a plurality of functions, and each function may be used to adjust a different second parameter. In an embodiment, the computing device 110 may match a target operation name against a plurality of adjustment operations. For example, the plurality of second parameters are in a one-to-one correspondence with the plurality of adjustment operations. In an embodiment, if a name of one of the plurality of adjustment operations is the same as the target operation name, the adjustment operation is determined as the target adjustment. At this time, the adjustment of the target parameter may be completed directly through the adjustment operation.

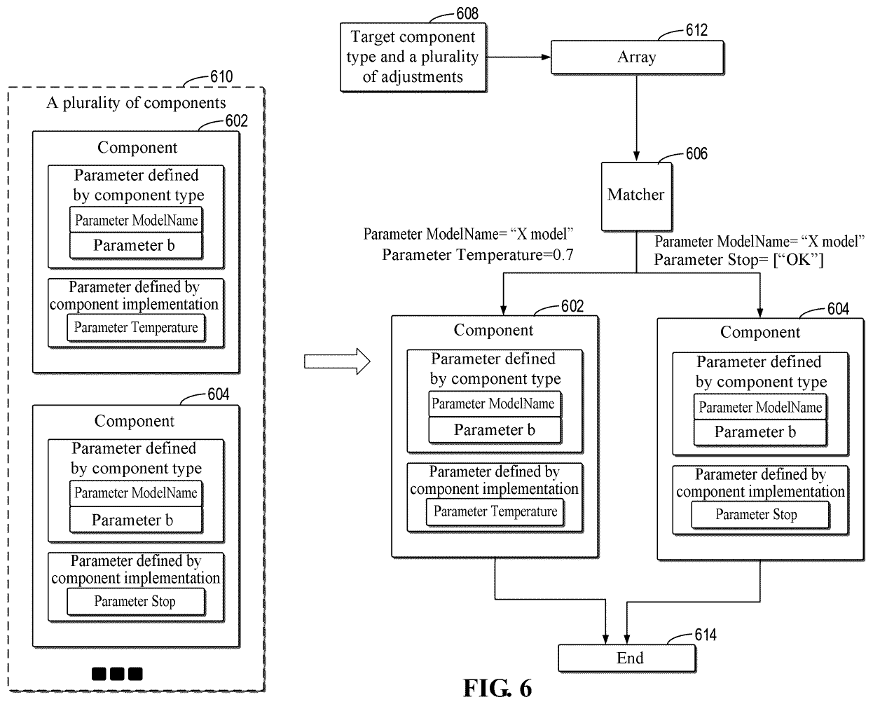

In some cases, the adjustment for a plurality of parameters may be processed simultaneously. FIG. 6 shows a schematic diagram of adjusting a parameter of a component according to an embodiment of the present disclosure. In this embodiment, the framework may include a plurality of components 610, which may involve different component types, for example, the component type of each of a component 602 and a component 604 is a component type A, and the component type of each of the other components is a component type B. The computing device 110 may receive a target component type, a target adjustment for a target parameter, and a plurality of second adjustments 608 from the computing device 120. In an embodiment, the plurality of second adjustments are obtained in the form of user input, which indicates the target component type and the plurality of second adjustments for the plurality of parameters. For example, the user desires to adjust a specific parameter (for example, a parameter ModelName) in the component type dimension and two specific parameters (for example, a parameter Temperature and a parameter Stop) in the component dimension. The computing device 110 may store the target adjustment and the plurality of second adjustments into an array (that is, a first data structure) 612. In this way, the traversal of the target adjustment and the plurality of second adjustments may be implemented by traversing the array 612.

When traversing the array 612, the matcher 606 obtains an adjustment operation from the first data structure as the traversed adjustment operation, and the adjustment operation is, for example, to adjust a variable ModelName. The target component type may be inferred (for example, through the name or call format of the adjustment operation) to be the component type A according to the adjustment operation. The component type associated with the traversed adjustment operation is matched against the type information of the plurality of first parameters. The matcher 606 may obtain the type information of the parameter ModelName through matching, and then may determine that the component type indicated by the type information of the parameter ModelName is the target component type. Therefore, the component types of both the component 602 and the component 604 are the target component type. When showing the distribution of the adjustment operation, the component 602 and the component 604 in the plurality of components 610 are shown on the right side of FIG. 6. The matcher 606 may transmit the read adjustment operation and the name of the target parameter to the component 602 and the component 604, and the component 602 and the component 604 may adjust the parameter ModelName according to the adjustment operation, so that the name of the model is modified to “model X” at each component.

Next, the matcher obtains another adjustment operation from the array 612 as the traversed adjustment operation. The adjustment operation is, for example, to adjust a variable Temperature. The component type associated with the traversed adjustment operation is matched against the type information of the plurality of first parameters, and it may also be determined that the component 602 and the component 604 are target components. Because further matching is required, the component 602 and the component 604 are determined as first components. The matcher 606 matches the type information of the second parameter Temperature of the first component 602 and the type of the second parameter Stop of the first component 604 against the component implementation information associated with the traversed adjustment operation, and may determine that the first component 602 is the target component. Therefore, the matcher 606 may distribute the adjustment operation to the first component 602 to adjust the value of the variable Temperature to 0.7. The next adjustment operation in the array 612 should be an adjustment operation for the variable Stop, and the matching and distribution process thereof is consistent with the process for the variable Temperature. The matcher 606 may distribute the next adjustment operation to the component 604 to adjust the value of the variable Stop to “OK”. After all adjustments are distributed, the parameter adjustment task may end at 614. In this embodiment, the array 612 may be used to process a plurality of adjustment operations at the same time, and the target parameter in the component type dimension and the target parameter in the component implementation dimension may be adjusted at the same time, which may improve the efficiency and accuracy of parameter adjustment.

In an embodiment, when obtaining the target component type, the target adjustment, and the second adjustment 608, a target identifier of the target component may also be obtained. Each of the plurality of components 610 may have an identifier. If the target identifier of the target component involved in the target parameter may be obtained in advance, the matcher 606 may be used to compare the target identifier with the identification of the component participating in matching. If the target identifier is the same as the identifier of the matched component, the component belongs to the component of the target category, and the second parameter of the component also matches the target implementation information successfully, the matcher 606 may distribute the target adjustment to the component to adjust the target parameter.

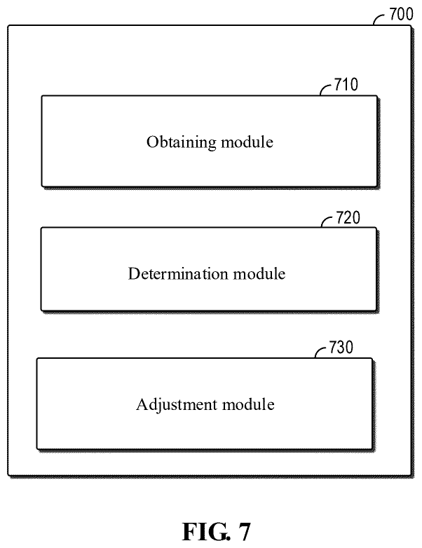

FIG. 7 shows a schematic block diagram of an example apparatus 700 according to some embodiments of the present disclosure. The apparatus 700 may be implemented in software, hardware, or a combination thereof. As shown in FIG. 7, the apparatus 700 includes an obtaining module 710, a determination module 720, and an adjustment module 730.

In some embodiments, the obtaining module 710 may be configured to obtain a target component type and a target adjustment for a target parameter. The determination module 720 may be configured to determine, from a plurality of components, at least one target component belonging to the target component type. The adjustment module 730 may be configured to adjust the target parameter of the at least one target component according to the target adjustment for the target parameter.

In some embodiments, the determination module 720 includes a second obtaining module, which is configured to obtain type information of a plurality of first parameters of the plurality of components. The determination module 720 further includes a first matching module, which is configured to match the target component type against the type information of the plurality of first parameters. The determination module 720 further includes a second determination module, which is configured to: in response to type information of at least one first parameter among the type information of the plurality of first parameters matching the target component type, determine a component including the type information of the at least one first parameter as the at least one target component.

In some embodiments, the adjustment module 730 includes a first traversal module, which is configured to perform the following operations for each of the at least one target component: obtaining a first parameter set of the target component according to the target component type; obtaining the target adjustment according to the target component type; and adjusting, by the target component, the target parameter in the first parameter set using the target adjustment.

In some embodiments, the target component is in a one-to-one correspondence with the first parameter set, and the first traversal module includes an address obtaining module, which is configured to obtain an address of the first parameter set corresponding to the target component. The first traversal module further includes a third obtaining module, which is configured to obtain the first parameter set according to the address.

In some embodiments, the target adjustment includes target implementation information for the target parameter, the at least one target component includes a plurality of first components, and the apparatus 700 further includes a fourth obtaining module, which is configured to obtain type information of a plurality of second parameters of the plurality of first components. The apparatus 700 further includes a second matching module, which is configured to match the target implementation information against types of the plurality of second parameters. The apparatus 700 further includes a third determination module, which is configured to: in response to type information of at least one second parameter among the type information of the plurality of second parameters matching the target implementation information, determine a first component including the type information of the at least one second parameter as the at least one target component.

In some embodiments, the adjustment module 730 includes a fourth obtaining module, which is configured to obtain a second parameter set of the first component. The adjustment module 730 further includes a fifth obtaining module, which is configured to obtain the target adjustment of the first component. The adjustment module 730 further includes a second adjustment module, which is configured to adjust the target parameter in the second parameter set using the target adjustment.

In some embodiments, the first component is provided with a plurality of adjustment operations, the plurality of adjustment operations include the target adjustment, the target adjustment includes a target operation name, and the fifth obtaining module includes a fourth matching module, which is configured to match the target operation name against the plurality of adjustment operations. The fifth obtaining module further includes a fourth determination module, which is configured to: in response to a name of one of the plurality of adjustment operations being the same as the target operation name, determine the adjustment operation as the target adjustment.

In some embodiments, the second parameter set includes a plurality of second parameters, and the plurality of second parameters are in a one-to-one correspondence with the plurality of adjustment operations.

In some embodiments, the apparatus 700 further includes a sixth obtaining module, which is configured to obtain user input, where the user input indicates the target component type and a plurality of second adjustments for a plurality of parameters. The apparatus 700 further includes a storage module, which is configured to store the target adjustment and the plurality of second adjustments into a first data structure.

In some embodiments, the first matching module includes a second traversal module, which is configured to traverse the first data structure according to the following operations: obtaining one adjustment operation from the first data structure as a traversed adjustment operation; and matching a component type associated with the traversed adjustment operation against the type information of the plurality of first parameters.

According to the apparatus of the embodiments of the present disclosure, matching in the dimension of the target component type may be performed by using the target component type, and the at least one target component belonging to the target component type may be obtained by filtering, so as to accurately adjust the parameter of the target component without causing the parameter of the component of the non-target component type to be changed, thereby avoiding the confusion in parameter adjustment.

The division of modules or units in the embodiments of the present disclosure is illustrative, and is only a logical function division. In actual implementation, there may be other division methods. In addition, the functional units in the disclosed embodiments may be integrated into one unit, each unit may be physically displayed separately, or two or more units may be integrated into one unit. The above integrated unit may be implemented in the form of hardware or software functional units.

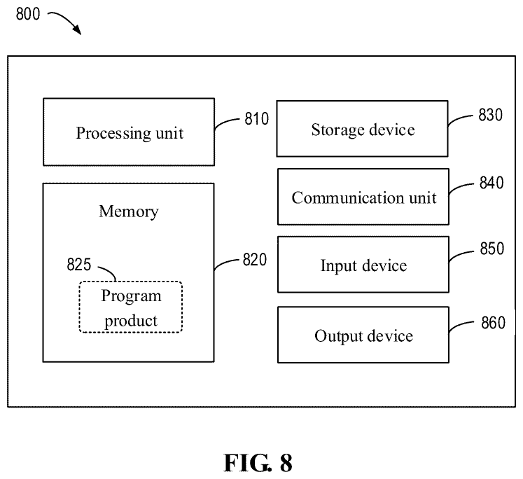

FIG. 8 shows a block diagram of an example device 800 that may be used to implement the embodiments of the present disclosure. It should be understood that the device 800 shown in FIG. 8 is only an example, and should not impose any limitation to the functions and scope of the implementations described herein. For example, the device 800 may correspond to the computing device 120 described herein with reference to FIG. 1, and may be used to perform the processes in FIG. 1 to FIG. 6 described above.

As shown in FIG. 8, the device 800 is in the form of a general-purpose computing device. The components of the computing device 800 may include, but are not limited to, one or more processors or processing units 810, a memory 820, a storage device 830, one or more communication units 840, one or more input devices 850, and one or more output devices 860. The processing unit 810 may be an actual or virtual processor, and may perform various processing according to programs stored in the memory 820. In a multi-processor system, a plurality of processing units execute computer-executable instructions in parallel to improve the parallel processing capability of the computing device 800.

The computing device 800 usually includes a plurality of computer storage medium. Such medium may be any available medium that is accessible by the computing device 800, including, but not limited to, volatile and non-volatile medium, and removable and non-removable medium. The memory 820 may be a volatile memory (such as a register, cache, or a random access memory (RAM)), a non-volatile memory (such as a read-only memory (ROM), an electrically erasable programmable read-only memory (EEPROM), or a flash memory), or any combination thereof. The storage device 830 may be any removable or non-removable medium, and may include a machine-readable medium, such as a flash drive, a disk, or any other medium, which may be used to store information and/or data (such as training data for training) and may be accessed within the computing device 800.

The computing device 800 may further include additional removable/non-removable, volatile/non-volatile memory medium. Although not shown in FIG. 8, a disk drive for reading from or writing into removable and non-volatile disks (such as a “floppy disk”), and an optical disk drive for reading from or writing into removable and non-volatile optical disks may be provided. In these cases, each drive may be connected to a bus (not shown) via one or more data medium interfaces. The memory 820 may include a computer program product 825, which has one or more program modules configured to perform various methods or actions of various implementations of the present disclosure.

The communication unit 840 implements communication with other computing devices via a communication medium. Additionally, the functions of the components of the computing device 800 may be implemented in a single computing cluster or a plurality of computing machines, which may communicate via communication connections. Therefore, the computing device 800 may perform operations in a networked environment using a logical connection with one or more other servers, a network personal computer (PC), or another network node.

The input device 850 may be one or more input devices, such as a mouse, a keyboard, or a tracking ball. The output device 860 may be one or more output devices, such as a display, a speaker, or a printer. The computing device 800 may further communicate with one or more external devices (not shown) via the communication unit 840 as needed, the external devices such as a storage device or a display device, communicate with one or more devices that enable the user to interact with the computing device 800, or communicate with any devices (such as a network card or a modem) that enable the computing device 800 to communicate with one or more other computing devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, where the computer-executable instructions are executed by a processor to implement the method described above. According to an example implementation of the present disclosure, there is provided a computer program product having a computer program stored thereon, where the program, when executed by a processor, implements the method described above.

Various aspects of the present disclosure are described herein with reference to the flowcharts and/or block diagrams of the method, the apparatus, the device, and the computer program product implemented according to the present disclosure. It should be understood that each block of the flowcharts and/or block diagrams, and combinations of the blocks in the flowcharts and/or block diagrams may be implemented by computer-readable program instructions.

These computer-readable program instructions may be provided to the processing unit of a general-purpose computer, a special-purpose computer, or another programmable data processing apparatus to produce a machine, such that the instructions, when executed by the processing unit of the computer or another programmable data processing apparatus, produce an apparatus for implementing a specific function/action in one or more blocks of the flowcharts and/or block diagrams. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the specific function/action in one or more blocks of the flowcharts and/or block diagrams.

The computer-readable program instructions may be loaded onto a computer, another programmable data processing apparatus, or another device, so that a series of operation steps are performed on the computer, the another programmable data processing apparatus, or the another device to produce a computer-implemented process, such that the instructions executed on the computer, the another programmable data processing apparatus, or the another device implement the specific function/action in one or more blocks of the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowcharts or block diagrams may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts may be implemented with a special-purpose hardware-based system that executes specified functions or actions, or may be implemented with a combination of special-purpose hardware and computer instructions.

The implementations of the present disclosure have been described above, and the above description is exemplary, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical applications, or the improvements to the technologies in the market, or to enable other persons of ordinary skill in the art to understand the implementations disclosed herein.

I/We claim:

1. A method for adjusting a parameter of a component, comprising:
obtaining a target component type and a target adjustment for a target parameter;
determining, from a plurality of components, at least one target component belonging to the target component type; and
adjusting the target parameter of the at least one target component according to the target adjustment for the target parameter.

2. The method of claim 1, wherein determining, from the plurality of components, the at least one target component belonging to the target component type comprises:
obtaining type information of a plurality of first parameters of the plurality of components;
matching the target component type against the type information of the plurality of first parameters; and
in response to type information of at least one first parameter among the type information of the plurality of first parameters matching the target component type, determining a component comprising the type information of the at least one first parameter as the at least one target component.

3. The method of claim 2, wherein adjusting the target parameter of the at least one target component according to the target adjustment for the target parameter comprises:
for each of the at least one target component, performing following operations:
obtaining a first parameter set of the target component according to the target component type;
obtaining the target adjustment according to the target component type; and
adjusting, by the target component, the target parameter in the first parameter set using the target adjustment.

4. The method of claim 3, wherein the target component is in a one-to-one correspondence with the first parameter set, and obtaining the first parameter set of the target component according to the target component type comprises:
obtaining an address of the first parameter set corresponding to the target component; and
obtaining the first parameter set according to the address.

5. The method of claim 2, wherein the target adjustment comprises target implementation information for the target parameter, the at least one target component comprises a plurality of first components, and the method further comprises:
obtaining type information of a plurality of second parameters of the plurality of first components;
matching the target implementation information against types of the plurality of second parameters; and
in response to type information of at least one second parameter among the type information of the plurality of second parameters matching the target implementation information, determining a first component comprising the type information of the at least one second parameter as the at least one target component.

6. The method of claim 5, wherein adjusting the target parameter of the at least one target component according to the target adjustment for the target parameter comprises:
obtaining a second parameter set of the first component;
obtaining the target adjustment of the first component; and
adjusting the target parameter in the second parameter set using the target adjustment.

7. The method of claim 6, wherein the first component is provided with a plurality of adjustment operations, the plurality of adjustment operations comprise the target adjustment, the target adjustment comprises a target operation name, and obtaining the target adjustment of the first component comprises:
matching the target operation name against the plurality of adjustment operations; and
in response to a name of one of the plurality of adjustment operations being the same as the target operation name, determining the adjustment operation as the target adjustment.

8. The method of claim 7, wherein the second parameter set comprises a plurality of second parameters, and the plurality of second parameters are in a one-to-one correspondence with the plurality of adjustment operations.

9. The method of claim 2, further comprising:
obtaining user input, wherein the user input indicates the target component type and a plurality of second adjustments for a plurality of parameters; and
storing the target adjustment and the plurality of second adjustments into a first data structure.

10. The method of claim 9, wherein matching the target component type against the type information of the plurality of first parameters comprises:
traversing the first data structure according to the following operations:
obtaining an adjustment operation from the first data structure as a traversed adjustment operation; and
matching a component type associated with the traversed adjustment operation against the type information of the plurality of first parameters.

11. An electronic device, comprising:
at least one processing unit; and
at least one memory, wherein the at least one memory is coupled to the at least one processing unit, and stores instructions executable by the at least one processing unit, the instructions, when executed by the at least one processing unit, cause the electronic device to:
obtain a target component type and a target adjustment for a target parameter;
determine, from a plurality of components, at least one target component belonging to the target component type; and
adjust the target parameter of the at least one target component according to the target adjustment for the target parameter.

12. The electronic device of claim 11, wherein the instructions further cause the electronic device to:
obtain type information of a plurality of first parameters of the plurality of components;
match the target component type against the type information of the plurality of first parameters; and
in response to type information of at least one first parameter among the type information of the plurality of first parameters matching the target component type, determine a component comprising the type information of the at least one first parameter as the at least one target component.

13. The electronic device of claim 12, wherein the instructions further cause the electronic device to:
for each of the at least one target component, performing following operations:
obtain a first parameter set of the target component according to the target component type;
obtain the target adjustment according to the target component type; and
adjust, by the target component, the target parameter in the first parameter set using the target adjustment.

14. The electronic device of claim 13, wherein the target component is in a one-to-one correspondence with the first parameter set, and the instructions further cause the electronic device to:
obtain an address of the first parameter set corresponding to the target component; and
obtain the first parameter set according to the address.

15. The electronic device of claim 12, wherein the target adjustment comprises target implementation information for the target parameter, the at least one target component comprises a plurality of first components, and the instructions further cause the electronic device to:
obtain type information of a plurality of second parameters of the plurality of first components;
match the target implementation information against types of the plurality of second parameters; and
in response to type information of at least one second parameter among the type information of the plurality of second parameters matching the target implementation information, determine a first component comprising the type information of the at least one second parameter as the at least one target component.

16. The electronic device of claim 15, wherein the instructions further cause the electronic device to:
obtain a second parameter set of the first component;
obtain the target adjustment of the first component; and
adjust the target parameter in the second parameter set using the target adjustment.

17. The electronic device of claim 16, wherein the first component is provided with a plurality of adjustment operations, the plurality of adjustment operations comprise the target adjustment, the target adjustment comprises a target operation name, and the instructions further cause the electronic device to:
match the target operation name against the plurality of adjustment operations; and
in response to a name of one of the plurality of adjustment operations being the same as the target operation name, determine the adjustment operation as the target adjustment.

18. The electronic device of claim 17, wherein the second parameter set comprises a plurality of second parameters, and the plurality of second parameters are in a one-to-one correspondence with the plurality of adjustment operations.

19. The electronic device of claim 12, wherein the instructions further cause the electronic device to:
obtain user input, wherein the user input indicates the target component type and a plurality of second adjustments for a plurality of parameters; and
store the target adjustment and the plurality of second adjustments into a first data structure.

20. A non-transitory computer-readable storage medium, wherein the computer-readable storage medium having computer-executable instructions stored thereon, wherein the computer-executable instructions, when executed by a processor, cause the processor to:
obtain a target component type and a target adjustment for a target parameter;
determine, from a plurality of components, at least one target component belonging to the target component type; and
adjust the target parameter of the at least one target component according to the target adjustment for the target parameter.
